(19) United States
(12) Patent Application Publication
(10) Pub. No.: US 2024/0282343 A1
(43) Pub. Date: Aug. 22, 2024

(54) SYSTEM AND METHOD OF VIDEO EDITING BY A VIDEO PLAYER

(71) Applicant: Idomoo LTD, Raanana (IL)

(72) Inventor: Danny KALISH, Raanana (IL)

(21) Appl. No.: 18/583,043

(22) Filed: Feb. 21, 2024

Related U.S. Application Data
(60) Provisional application No. 63/486,091, filed on Feb. 21, 2023.

(51) Int. Cl. G11B 27/031; G06F 3/0484

(52) U.S. Cl. CPC G11B 27/031; G06F 3/0484

(57) ABSTRACT

A method for receiving user input in editing video, the method including the steps of pausing video at pre-defined frame with customized data including data design properties: color, from, location on screen, bounding box, opening editing window for entering customized data at the location where the data appears in the video itself, receiving user customized data text or voice, showing user personal data enabling to correct change, updating video with the entered data or using overlay, presenting user the video frame with the edited data at the same location it appears in the video, sending updated/new video back to the player, and generating news frames, updating frames or generating updating video layer based on customized data.

### BACKGROUND

### Technical Field

The present invention relates generally to editing process in a video player.

### SUMMARY

The present invention provides a method for receiving user input in editing video, said method comprising the steps of:
Pausing video at pre-defined frame with customized data including data design properties: color, from, location on screen, bounding box
Opening editing window for entering customized data at the location where the data appears in the video itself
Receive user customized data text or voice, showing user personal data enabling to correct change;
Updating video with the entered data or using overlay, presenting user the video frame with the edited data at the same location it appears in the video;
Sending updated/new video back to the player
Generating news frames, updating frames or generating updating video layer based on customized data

The present invention provides a method for delayed actions or video editing, said method comprising the steps of:
Receive user customized data
Pausing video at pre-defined frame based customized data
Using customized data with API of external service or uploading web page using the data for external action
Applying action according to external service or sending instruction to the external service;

Optionally Saving data for future, delayed action based on (trigger within the movie), or input data from the user.

The present invention provides a method for receiving user input in editing video implemented on at least one non-transitory computer readable storage device and one or more processors operatively coupled to the storage device on which are stored modules of instruction code which when executed by said one or more processors implements:
Pausing video at pre-defined frame with customized data, starting editing session;
retrieving/identifying data design properties of the predefined video frame including format, location of object on screen, bounding box and color.
Opening and presenting an editing window overlaying the predefined video frame, wherein the editing window is configured to enable the user, entering customized data at the location where the data appears in the original pre-defined video frame, wherein the editing window inherent all design properties of the video pre-defined frame based on known location of all objects and all design properties within the video;
Receive user customized data text or voice, showing user personal data within the opened editing window, wherein the user is enabled to correct or change customized during editing session;
at the end of the editing session, updating the pre-defined frames with the receive user customized data.

According to some embodiments of the present invention multiple frames which are updated based the entered customized are edited at any part of the video. According to some embodiments of the present invention the update of the frame video is performed at a remote server which sends updated video back to the player.

According to some embodiments of the present invention, after the video is updated, the player continuously plays the video, from the point of the predefined frame.

The present invention provides a method for executing delayed actions during video session, implemented on at least one non-transitory computer readable storage device and one or more processors operatively coupled to the storage device on which are stored modules of instruction code which when executed by said one or more processors implements:
receive user customized data during video playing;
using customized data with API of external service or uploading web page using the data for determining an action to be performed on the user device based on pre-defined rules;
applying determined action using external service or sending instruction to the external service to perform the action;

According to some embodiments of the present invention the method further comprises the step of saving data for future, delayed action based on trigger within the movie or input data from the user.

According to some embodiments of the present invention the method further redirecting to internal links in the video or external hyperlinks during the video playing, wherein these links can direct users to websites or mobile applications, further integrating the video content with external digital resources.

According to some embodiments of the present invention the method further comprising the step of: —Pausing video at pre-defined frame by applying rules based on received customized data.

The present invention provides a system for receiving user input in editing video implemented on at least one non-transitory computer readable storage device and one or more processors operatively coupled to the storage device on which are stored modules of instruction code which when executed by said one or more processors implements:
interface module configured to Pausing video at pre-defined frame with customized data, starting editing session, retrieving/identifying data design properties of the predefined video frame including: format, location of object on screen, bounding box and color, Opening and presenting an editing window overlaying the predefined video frame, wherein the editing window is configured to enable the user, entering customized data at the location where the data appears in the original pre-defined video frame, wherein the editing window inherent all design properties of the video pre-defined frame based on known location of all objects and all design properties within the video;
Receive user customized data text or voice, showing user personal data within the opened editing window, wherein the user is enabled to correct or change customized during editing session;
video generation module configured to updating the pre-defined frames with the receive user customized data, at the end of the editing session.

According to some embodiments of the present invention multiple frames which are updated based the entered customized are edited at any part of the video. According to some embodiments of the present invention the update of the frame video is performed at a remote server which sends updated video back to the player.

According to some embodiments of the present invention the method further after the video is updated, the player continuously plays the video, from the point of the predefined frame.

The present invention provides a system for executing delayed actions during video session, implemented on at least one non-transitory computer readable storage device and one or more processors operatively coupled to the storage device on which are stored modules of instruction code which when executed by said one or more processors implements:
interaction module configured to receive user customized data during video playing, Pausing video at pre-defined frame by applying rules based on received customized data, Using customized data with API of external service or uploading web page using the data for determining an action to be performed on the user device based on pre-defined rules and applying determined action using external service or sending instruction to the external service to perform the action;

According to some embodiments of the present invention the customized data is saved for future, delayed action based on trigger within the movie or input data from the user.

According to some embodiments of the present invention interaction module is further configured to redirected to internal links in the video or external hyperlinks during the video playing, wherein these links can direct users to websites or mobile applications, further integrating the video content with external digital resources.

According to some embodiments of the present invention the interaction module is further configured to pause video at pre-defined frame by applying rules based on received customized data;

### BRIEF DESCRIPTION OF THE SCHEMATICS

The present invention will be more readily understood from the detailed description of embodiments thereof made in conjunction with the accompanying drawings of which:

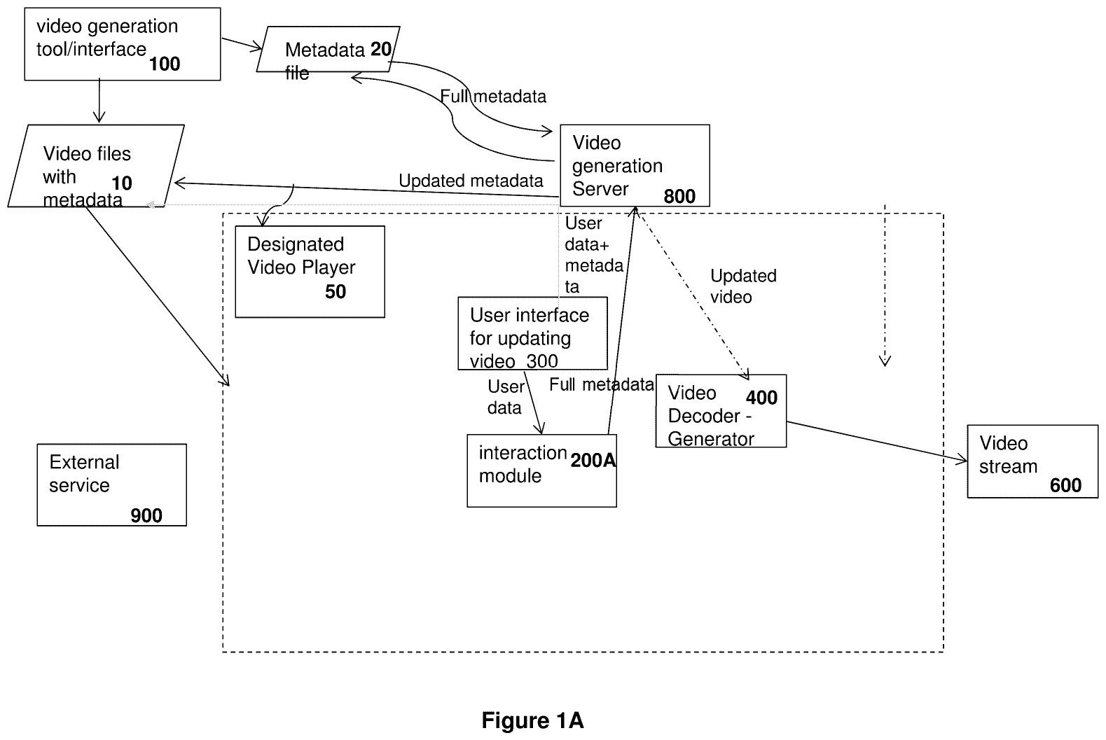

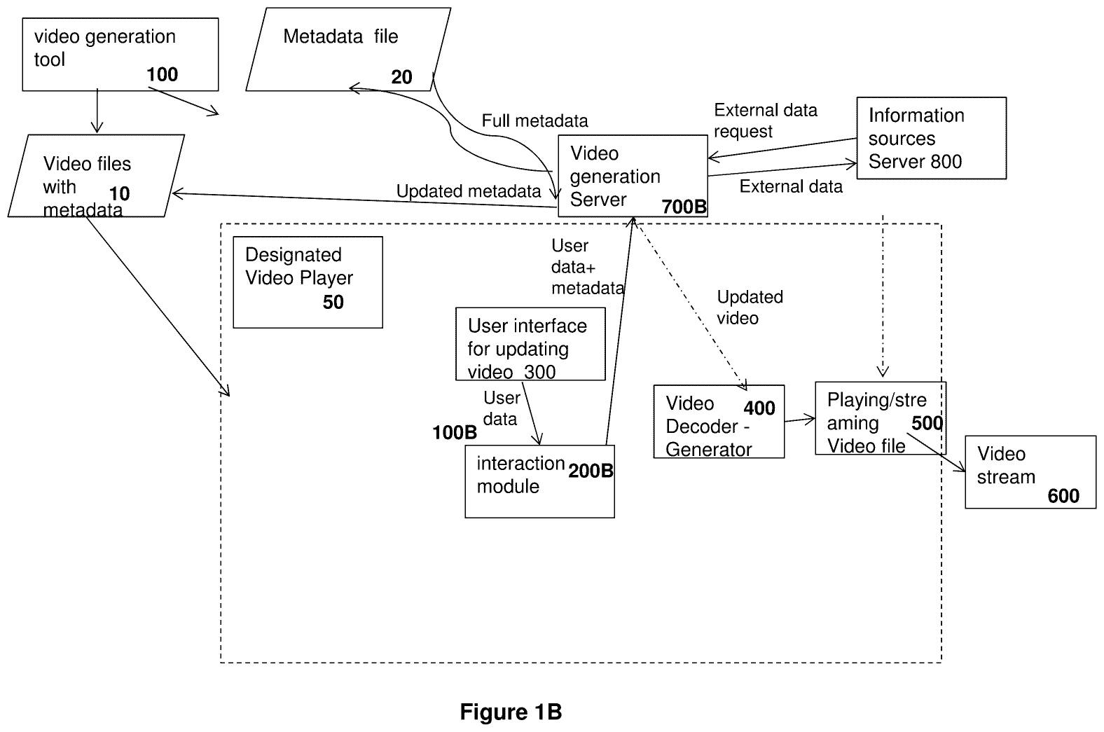

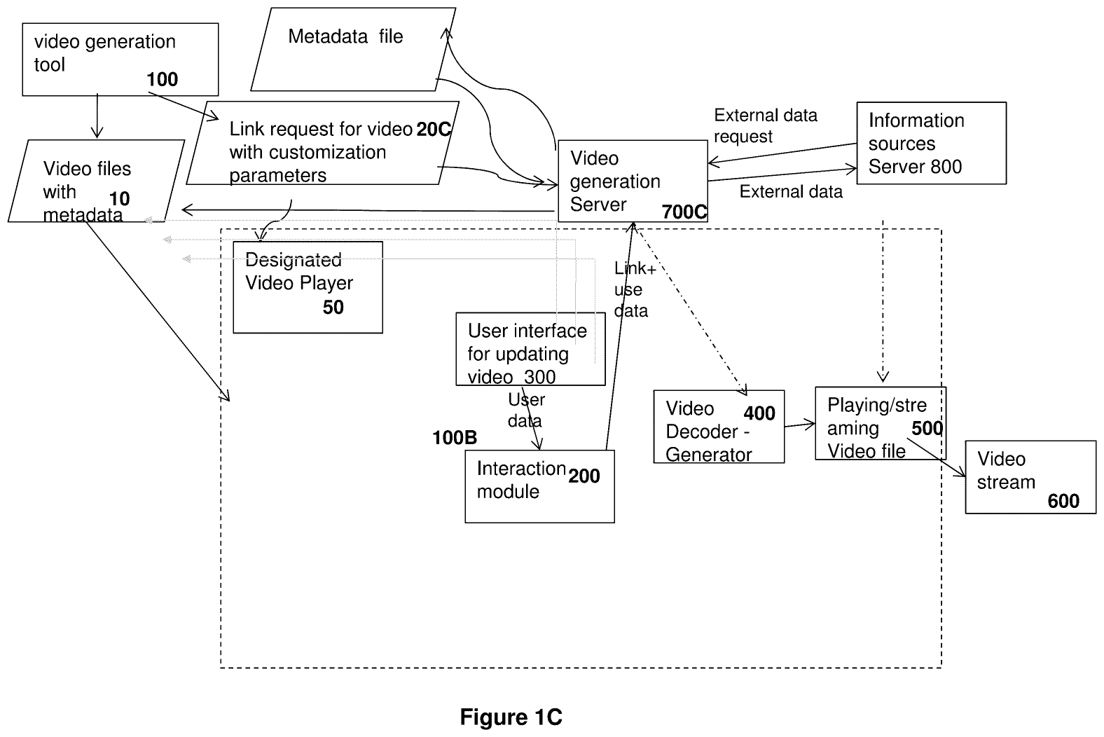

FIG. 1A is a block diagram, depicting the components and the environment of the video management system, according to some embodiments of the invention.

FIG. 1B is a block diagram, depicting the components and the environment of the video management system, according to some embodiments of the invention.

FIG. 1C is a block diagram, depicting the components and the environment of the video management system, according to some embodiments of the invention.

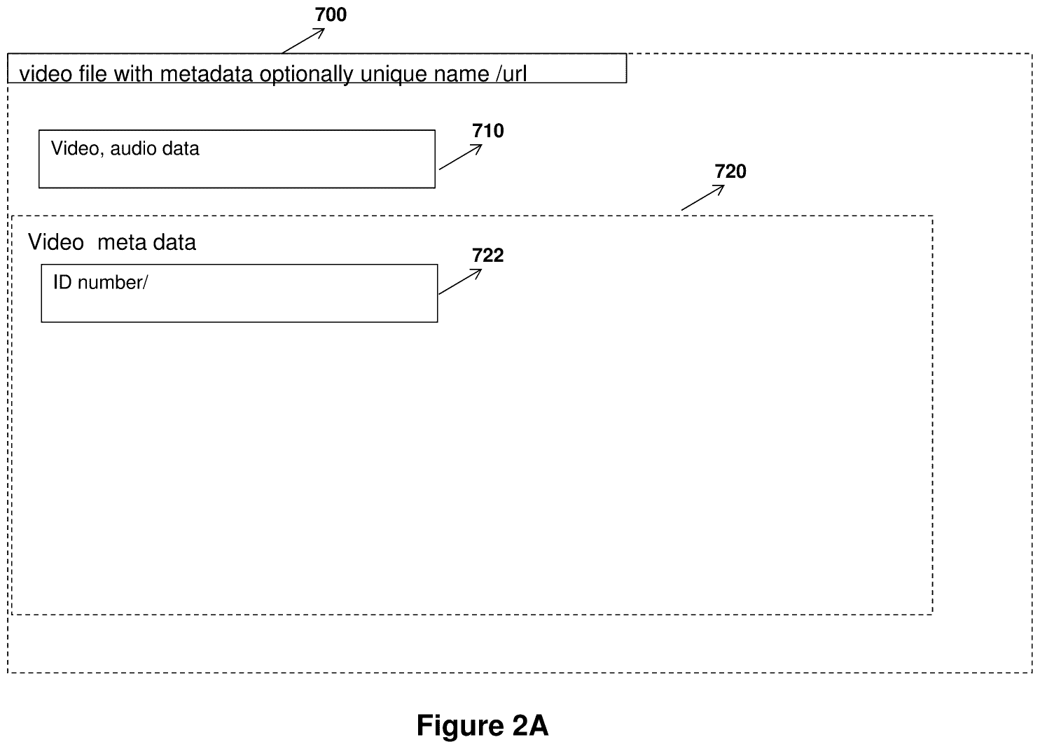

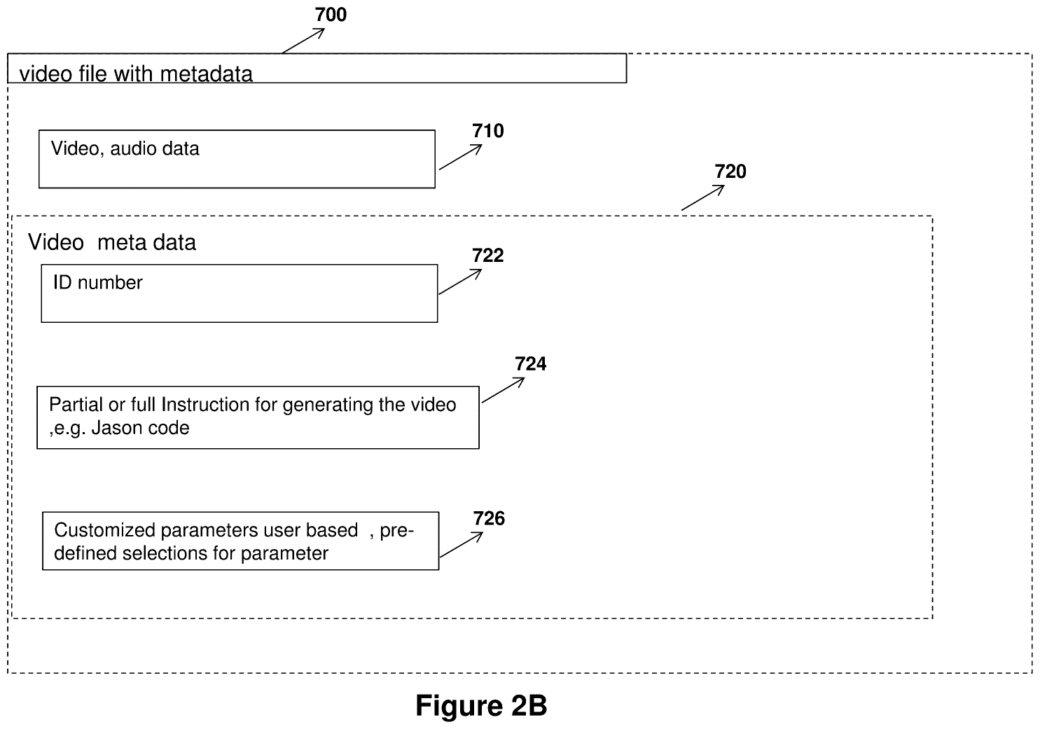

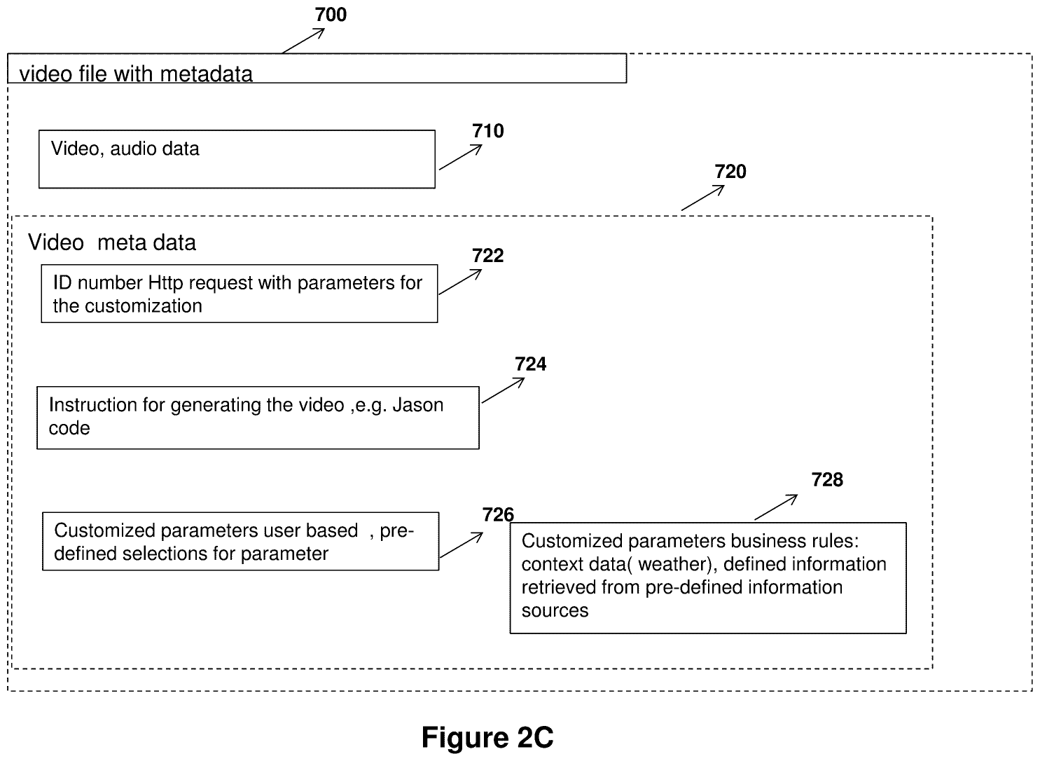

FIG. 2A is a block diagram depicting the video file format information structure, according to one embodiment of the invention.

FIG. 2B is a block diagram depicting the video file format information structure, according to one embodiment of the invention.

FIG. 2C is a block diagram depicting the video file format information structure, according to one embodiment of the invention.

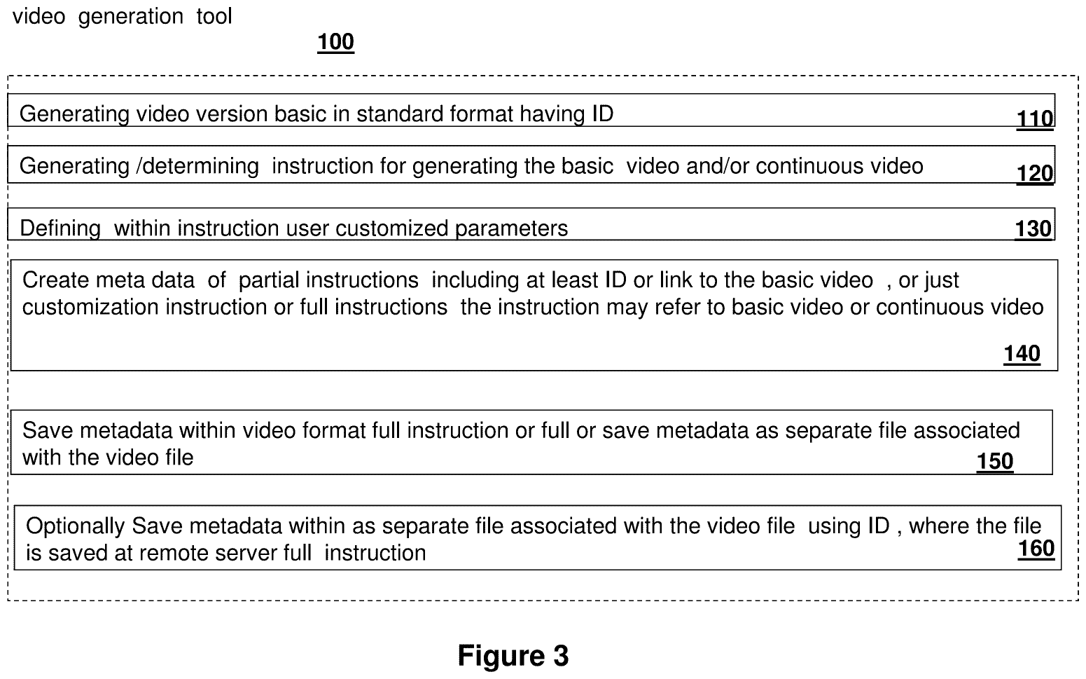

FIG. 3 is a flowchart depicting the video generation tool 100, according to some embodiments of the invention;

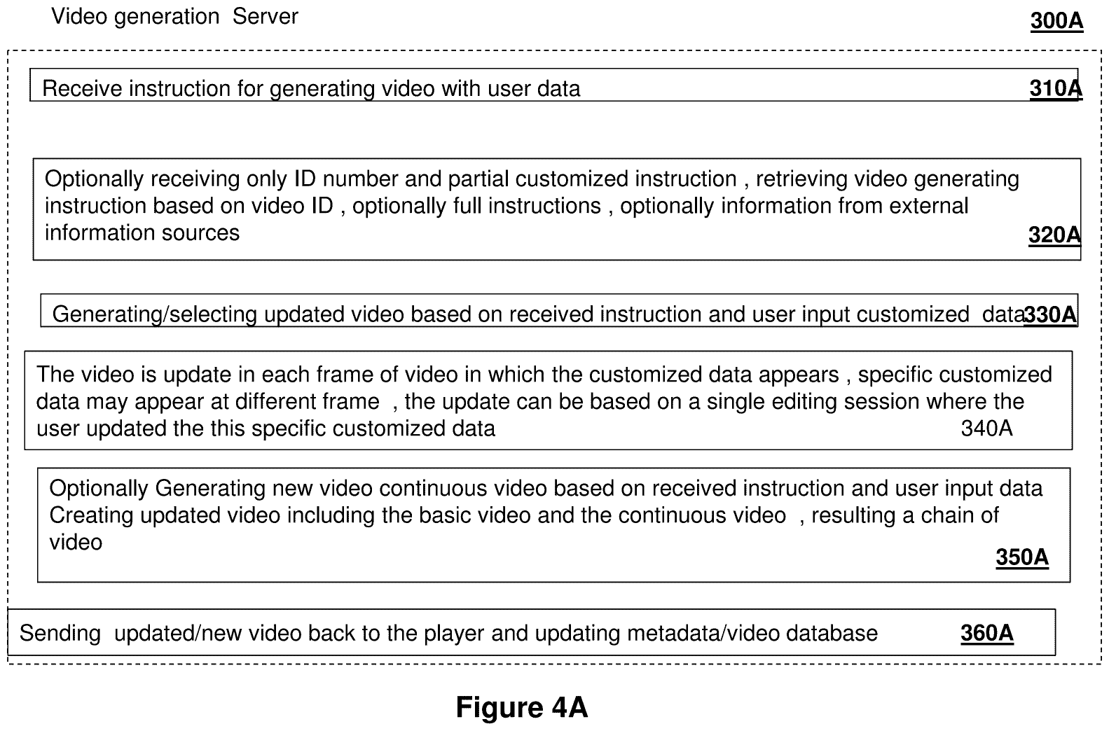

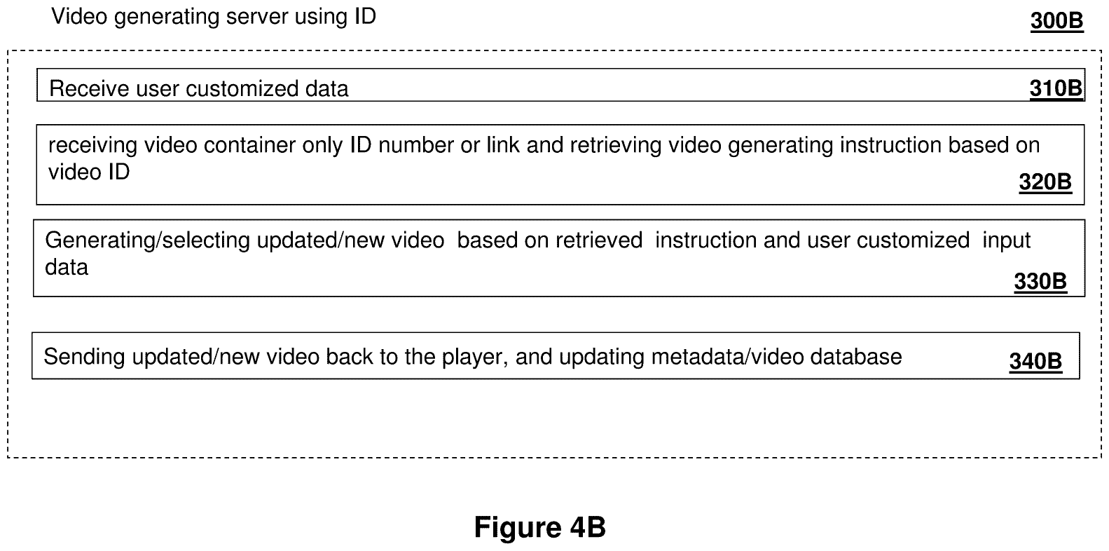

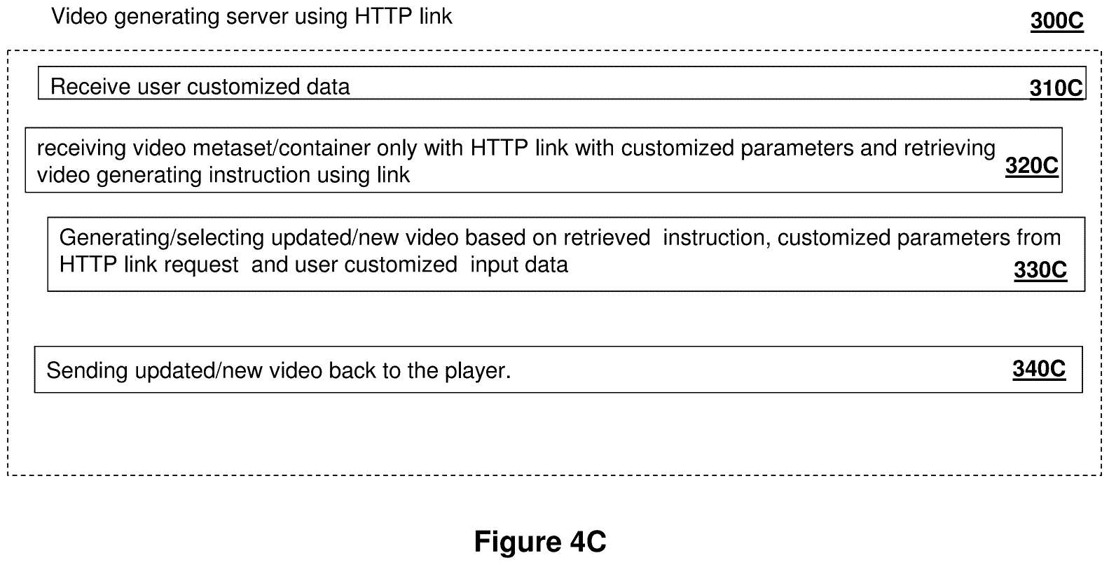

FIG. 4A presents a flowchart, depicting the video generating server, according to some embodiments of the invention.

FIG. 4B presents a flowchart, depicting the video generating server, according to some embodiments of the invention.

FIG. 4C presents a flowchart, depicting the video generating server, according to some embodiments of the invention.

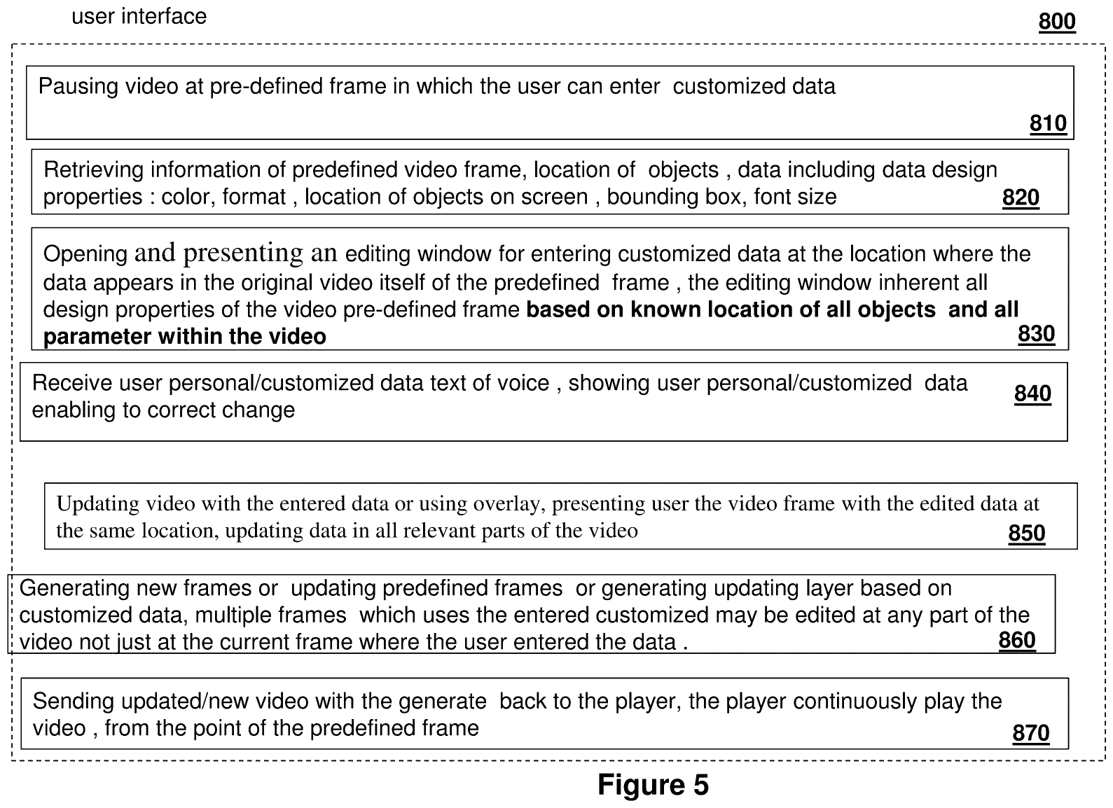

FIG. 5 presents a flowchart, depicting the user interface module, according to some embodiments of the invention.

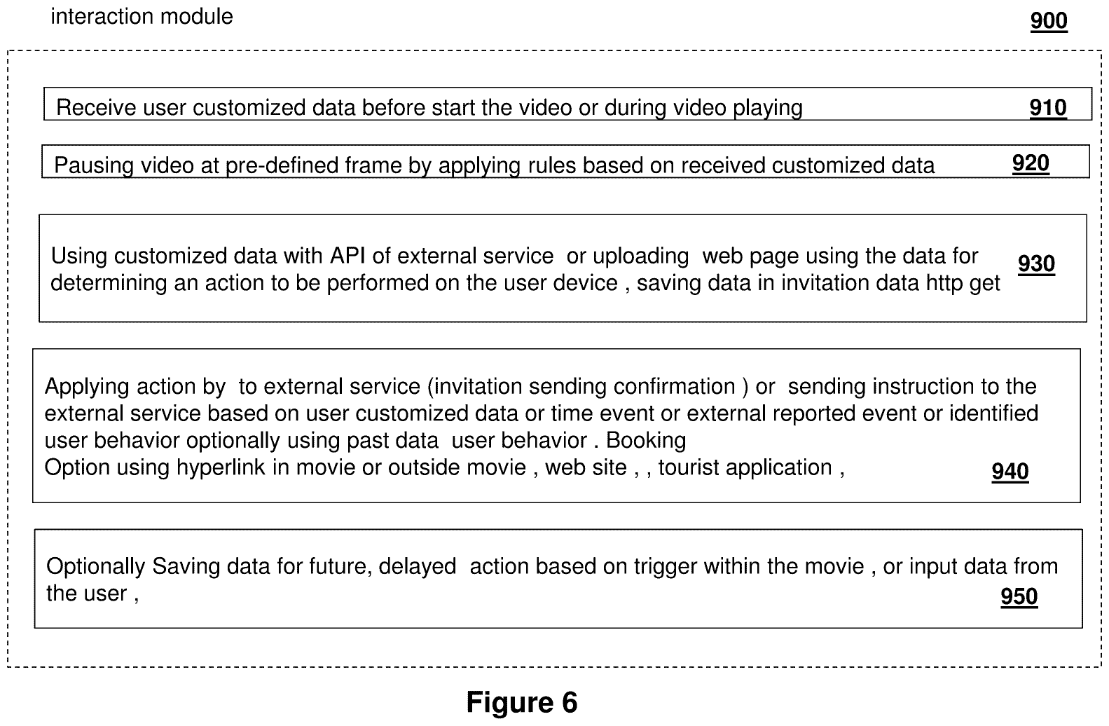

FIG. 6 presents a flowchart, depicting the user interaction module, according to some embodiments of the invention.

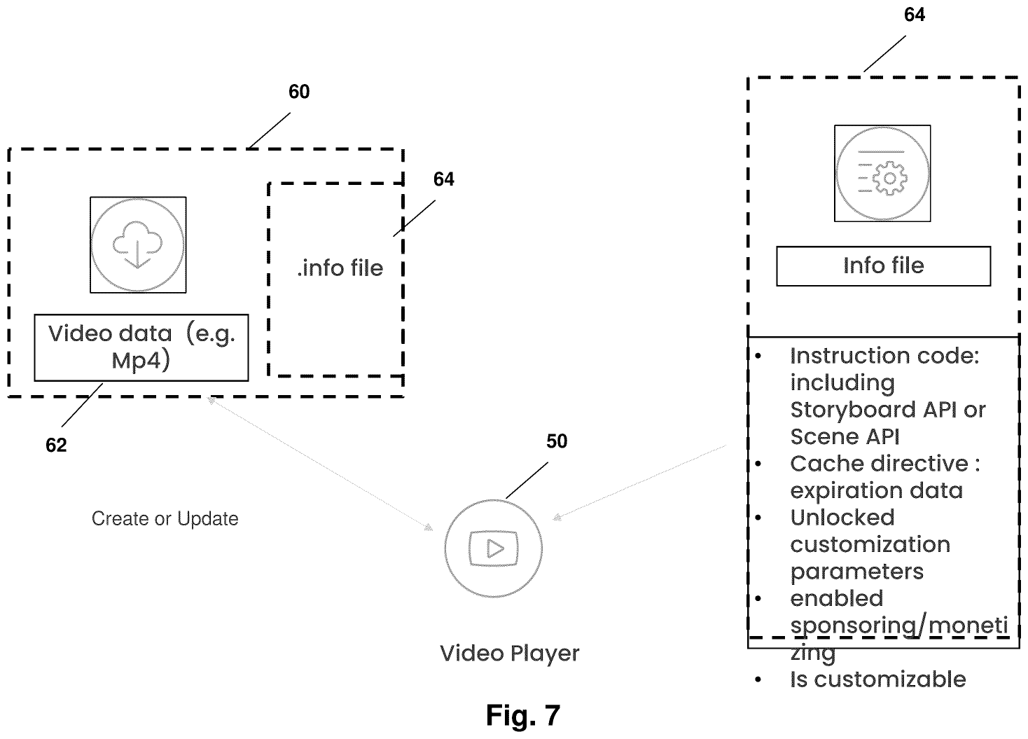

FIG. 7 illustrates an example of video file and Info file according to some embodiments of the present invention.

### DETAILED DESCRIPTION OF THE VARIOUS MODULES

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The following is a list of definitions of the terms used throughout this application, adjoined by their properties and examples.

### Definition

Video instruction metadata contains data that are essential for drawing blueprints for the scene: including at least one of the following:

A composition of what elements to draw and where/when/how they should be drawn, transformed, animated, etc.

The metadata may include text, images, and video, how they all move and appear throughout time together and with respect to each other.

The metadata includes data of the ‘scene graph’ of the scene (i.e., how the scene is to be drawn from all of its elements, and throughout time).

To draw the movie at a specific frame, we first tell the “uber” scene graph to “Set Frame ( )” which tells all of the individual components to configure themselves.

for the desired frame (i.e., set transformations (positions & rotation) values, any animatable values, to their expected values for that frame).

Then, second, we finally call Render ( ), which takes all of the data in its current configuration and draws the picture to a piece of memory called a ‘frame buffer.’

FIG. 1A is a block diagram, depicting the components and the environment of the video management system, according to some embodiments of the invention.

Designated Video Player 50 is comprised of User interface for updating video 300 interaction module 210 which are configured to enable user entering data while the video is running, where the inserted data is presented on the screen at the same location where the data in positioned with the video frame. The Designated Video Player 50 further comprises Video Decoder—Generator 500.

Video generation Server 800 is configured to generate/update the video based on video template received from the video generation tool/interface with meta data 20 or from database of Video files with metadata 10.

The video generation tool 100 is configured to produce a basic/original video in known formats, such as MP4, and meta data including identification and/or partial or full instructions for generating the video and/or version of the video, such as JSON description file and customization parameters. The metadata can be saved as part of the standard meta data of known video format such as Mp4. Optionally the meta data can be saved is a separate info file 20, which is associated with the basic original video file. The separate file 20 may be saved at remote server, optionally the video generation server 300. The sperate info file may include ID of the basic file or communication link to the basic file which is saved at remote server, such as the video generation server 300.

The designated video player 50, is configured to play the basic original video in incase conditions appearing meta data are met, otherwise the player sends the meta data which may include ID, link or instruction for generating the video with customized/personalized parameter to the video generation server 300. The player receives back the customized/updated new version video and play automatically this updated/new version video. This process may involve user interaction to customize the video.

FIG. 1B is a block diagram, depicting the components and the environment of the video management system, according to some embodiments of the invention.

According to this embodiment the video generating server, queries pre-defined information source 800 for predefined customization parameter defined in the metadata, in response to query request, an external information source, using a designated API, returns the required customized parameter data. The external information source may be for example news sites, organization databases etc.

According to this embodiment the video generating server, queries pre-defined information source 800 for predefined customization parameter defined in the metadata, in response to query request, an external information source, using a designated API, returns the required customized parameter data. The external information source may be for example news sites, organization databases etc.

FIG. 1C is a block diagram, depicting the components and the environment of the video management system, according to some embodiments of the invention.

According to this embodiment, the link of the video is an HTTP request which include meta data including at least one customized parameter data, which is sent by the player to the video generating server, to be used for the generation of the new version video.

FIG. 2A is a block diagram depicting the video file format information structure, according to one embodiment of the invention.

According to this embodiment, the video file format of digital media container 700 is comprised of video or audio data 710 and meta data 720. The metadata comprises only video ID or a link to the video 722, where metadata file is associated with the video ID or link.

FIG. 2B is a block diagram depicting the video file format information structure, according to one embodiment of the invention.

The video file format of digital media container 700 is comprised of video or audio data 710 and meta data 720. The meta data comprises at least video ID or a link 722 and/or optionally partial or full video generation instructions 724 and/or customized parameters 726. Optionally including Link to originating Video editor of full project data 728.

FIG. 2C is a block diagram depicting the video file format information structure, according to one embodiment of the invention.

The video file format of digital media container 700 is comprised of video or audio data 710 and meta data 720. The meta data comprises at least video ID or a link of an HTTP request 722 and/or optionally partial or full video generation instructions 724 and/or customized parameters 726. Optionally according to embodiments, the metadata comprise Customized parameters business rules: context data (weather), defined information retrieved from pre-defined information sources 728. For example, the information source may be databased of an organization associated with the basic video including data which is relevant to the generation of the video, such as available type of products or services, which appear in the video. The context data may relate to sensor data available.

FIG. 3 is a flowchart depicting the video generation tool 100, according to some embodiments of the invention;

The video generation is configured to implement, at least one of the followings steps:

Generating a basic original video version in standard format, optionally in designated format (step 110);

Generating/determining instruction for generating the basic original video and/or continuous video (step 120), The generation instruction may include script of the video which define objects, their properties, script of video, layers order information.

The instruction code may be for instance, a JSON code for generating a video as described above. When using video templates, the instruction code may include be in the form of a template.

Defining within instruction user customized parameters configured to change video parts, replace image part of image layers with frame, audio or text, (step 130);

Create meta data of partial instructions including at least ID or link to the basic video, or just customization instruction or full instructions; (step 140);

Save metadata within video format or save metadata as separate file associated with the video file (step 150), the sperate file is saved at remote server such as the video generating server 500;

FIG. 4A presents a flowchart, depicting the video generating server, according to some embodiments of the invention.

The video generating server is configured to implement, at least one of the followings steps:
Receive user customized data;
Receive instruction for generating video with user data; (step 310A);
Optionally receiving only ID number and partial customized instructions, retrieving video generating instruction based on video ID, optionally full instructions, optionally information from external information sources (step 320A);
Generating/selecting updated/new video version based on received instruction and user input data; (step 330A). Optionally receiving instructions for locking the video for further editing.

The video is update in each frame of video in which the customized data appears, specific customized data may appear at different frame, the update can be based on a single editing session where the user updated this specific customized data (340A)

Optionally Generating new continuous video based on received instruction and user input data and optionally creating a chain video including the generated updated/new video (from step 330A) and the continuous video (step 350A). Each user may create continuous new video part enabling to create chain video structure, where each new continuous video prolongs the former video. This may be used by a group of users wishing to create a happy birthday video which is generated by the different users, each composing a greeting video. According to some embodiments of the present invention the updated video is based on external information sources (such as weather data or stock market or any data based relevant for different users. Different source information may be used for each user.

Sending update new video version back to player; (step 360)

FIG. 4B presents a flowchart, depicting the video generating server, according to some embodiments of the invention.

The video generating server is configured to implement, at least one of the followings steps:
Receive user customized data (step 310B);
receiving video container only ID number or link and retrieving video generating instruction based on video ID (step 320B);
Generating/selecting updated/new video version based on received instruction and user input data (step 330B);
Sending updated/new video back to player (step 340B).

FIG. 4C presents a flowchart, depicting the video generating server, according to some embodiments of the invention.

The video generating server is configured to implement, at least one of the followings steps:

The video generating server is configured to implement, at least one of the followings steps:
Receive user customized data; (step 810C)
receiving video metaset/container only with HTTP link with customized parameters and retrieving video generating instruction using link; (step 820C);
Generating/selecting movie based on received instruction and user input data; (step 830C);
Sending updated/new video back to player (step 840C).

FIG. 5 presents a flowchart, depicting the user interface module, according to some embodiments of the invention.

The user interface module is configured to implement, at least one of the followings steps:
Pausing video at pre-defined frame in which the user can enter customized data (step 810);
Retrieving information of predefined video frame, location, data including data design properties: color, form, location on screen, bounding box, font size (step 820);
Opening and presenting editing window for entering customized data at the location where the data appears in the original video itself of the current (predefined) frame, the editing window inherent all design properties of the video pre-defined frame (830);
Receive user personal/customized data text of voice, showing user personal/customized data enabling to correct change (step 840);
Updating video with the entered data or using overlay, presenting user the video frame with the edited data at the same location, updating data in all relevant parts of the video (step 850);
Generating new frames, updating frames or generating updating layer based on customized data the frame may be at any part of the video not just at the current frame where the user entered data (step 860);
The generation or updated can made by the local device or by the video generating server. In the second option the customized data with the video link, ID or metadata of the video are sent to the video generating server
Sending updated/new video back to the player from this module or from the video generating server. (step 870).

FIG. 6 presents a flowchart, depicting the user interaction module, according to some embodiments of the invention.

The interaction module is configured to work with external computer platforms such as invitation management platforms (tickets, vacation), booking platforms, data entered by the user while playing the movie is shared with computer platforms and saved within their database. For example, in case the video of a hotel reservation, the user may enter customized data of dates, number of guests, this data is saved in the database of hotel invitation/reservation database.

The interaction module is configured to implement, at least one of the followings steps:
Receive user customized data before or during the video (step 910);
Pausing video at pre-defined frame based customized data step 920)
Using customized data with API of external service or uploading web page using the data for external action (step 930);
Applying action according to external service or sending instruction to the external service based on user customized data or time event or external reported event or identified user behavior optionally using past data user behavior.
Applying instructions to external service (invitation sending confirmation) or sending instruction to the external service based on user customized data or time event or external reported event or identified user behavior optionally using past data user behavior.

Optionally jumping to an external hyperlink within movie or outside movie such a web site or mobile application, such as tourist application, (step 940);

Optionally Saving data for future usage, delayed action based on trigger within the movie, or outside the movie (step 950).

FIG. 6 introduces a flowchart that details the functionalities of the user interaction module, as envisioned in various embodiments of the invention. This module is specifically designed to bridge the gap between video content and external computer platforms, such as invitation management platforms for events and bookings, and hotel reservation systems. By integrating with these external services, the module not only enhances user experience through interactive content but also facilitates the seamless execution of actions based on user input directly within the video interface.

The interaction module is adept at interfacing with various external computer platforms. For instance, when viewing a promotional video for hotel reservations, users can input their desired dates and number of guests directly into the video. This data is then communicated and stored within the hotel's booking database, simplifying the reservation process.

### Key Functionalities and Steps:

Receiving Customized User Data (Step 910): The module is capable of accepting user-input data, either before the video starts or during playback. This flexibility allows users to interact with the video content in real-time, tailoring their experience to their specific needs.
Pausing Video for Data Entry (Step 920): Based on the customized data provided by the user, the video can pause at predefined frames. This pause allows users to focus on inputting their data accurately, enhancing the interactive experience.
Integration with External Services (Step 930): Utilizing APIs from external services or uploading web pages, the module uses the entered data to perform actions outside the video. For example, it could automatically fill in a booking form on a hotel website with the user's provided data.
Executing Actions Based on External Services (Steps 930 & 940): The module applies actions according to instructions from external services or sends instructions based on various triggers such as user data, time events, external events, or identified user behaviors. This could include confirming an invitation or reservation. The module's ability to use historical data on user behavior enhances the personalization of these actions.
Navigation to Links (Step 940): Users have the option to jump to internal links in the video or external hyperlinks during or after the video. These links can direct users to websites or mobile applications, further integrating the video content with external digital resources.
Data Storage for Future Use (Step 950): The module can save user data for future actions, which may be triggered by events within the video or through external factors. This feature allows for delayed actions, such as sending reminders or promotional offers, based on the user's interaction with the video.

Through its innovative integration with external computer platforms and its sophisticated handling of user data, the user interaction module significantly enhances the interactive capabilities of video content. By enabling real-time data entry, seamless external actions, and personalized user experiences, this module exemplifies the potential for interactive videos to not only engage viewers but also to perform complex tasks and facilitate actions beyond traditional video playback. This represents a significant advancement in how video content can interact with and utilize external services to benefit the user.

FIG. 7 illustrates an example of video file and Info file according to some embodiments of the present invention.

The video 60 file includes video compressed data in know format, such MP4 and an info file including instruction data for generating the video: including Storyboard API or Scene API, Cache directive: expiration data, Unlocked.

The system of the present invention may include, according to certain embodiments of the invention, machine-readable memory containing or otherwise storing a program of instructions which, when executed by the machine, implements some or all of the apparatus, methods, features, and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general-purpose computer which may optionally be configured or activated in accordance with the teachings of the present invention. Any of the teachings incorporated herein may wherever suitable operate on signals representative of physical objects or substances.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field-programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read-only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

1. A method for receiving user input in editing video implemented on at least one non-transitory computer readable storage device and one or more processors operatively coupled to the storage device on which are stored modules of instruction code which when executed by said one or more processors implements:
Pausing video at pre-defined frame with customized data, starting editing session;
retrieving/identifying data design properties of the predefined video frame including format, location of object on screen, bounding box and color;
Opening and presenting an editing window overlaying the predefined video frame, wherein the editing window is configured to enable the user, entering customized data at the location where the data appears in the original pre-defined video frame, wherein the editing window inherent all design properties of the video pre-defined frame based on known location of all objects and all design properties within the video;
Receive user customized data text or voice, showing user personal data within the opened editing window, wherein the user is enabled to correct or change customized during editing session;
at the end of the editing session, updating the pre-defined frames with the receive user customized data.

2. The method of claim 1 wherein multiple frames which are updated based the entered customized are edited at any part of the video.

3. The method of claim 1 wherein the update of the frame video is performed at a remote server which sends updated video back to the player.

4. The method of claim 1 wherein after the video is updated, the player continuously plays the video, from the point of the predefined frame.

5. A method for executing delayed actions during video session, implemented on at least one non-transitory computer readable storage device and one or more processors operatively coupled to the storage device on which are stored modules of instruction code which when executed by said one or more processors implements:
receive user customized data during video playing;
using customized data with API of external service or uploading web page using the data for determining an action to be performed on the user device based on pre-defined rules;
applying determined action using external service or sending instruction to the external service to perform the action.

6. The method of claim 5 further comprising the step of saving data for future, delayed action based on trigger within the movie or input data from the user.

7. The method of claim 5 further comprising the step of redirecting to internal links in the video or external hyperlinks during the video playing, wherein these links can direct users to websites or mobile applications, further integrating the video content with external digital resources.

8. The method of claim 5 further comprising the step of: —Pausing video at pre-defined frame by applying rules based on received customized data.

9. A system for receiving user input in editing video implemented on at least one non-transitory computer readable storage device and one or more processors operatively coupled to the storage device on which are stored modules of instruction code which when executed by said one or more processors implements:
interface module configured to Pausing video at pre-defined frame with customized data, starting editing session, retrieving/identifying data design properties of the predefined video frame including: format, location of object on screen, bounding box and color, Opening and presenting an editing window overlaying the predefined video frame, wherein the editing window is configured to enable the user, entering customized data at the location where the data appears in the original pre-defined video frame, wherein the editing window inherent all design properties of the video pre-defined frame based on known location of all objects and all design properties within the video;
Receive user customized data text or voice, showing user personal data within the opened editing window, wherein the user is enabled to correct or change customized during editing session;
video generation module configured to updating the pre-defined frames with the receive user customized data, at the end of the editing session.

10. The system of claim 8 wherein multiple frames which are updated based the entered customized are edited at any part of the video.

11. The system of claim 8 wherein the update of the frame video is performed at a remote server which sends updated video back to the player.

12. The system of claim 8 wherein after the video is updated, the player continuously plays the video, from the point of the predefined frame.

13-15. (canceled)
